(19) United States
(12) Patent Application Publication
(10) Pub. No.: US 2026/0236772 A1
(43) Pub. Date: Aug. 13, 2026

(54) INFERENCE-DRIVEN MODEL PRUNING

(71) Applicant: Cisco Technology, Inc., San Jose, CA (US)

(72) Inventors: Charles Fleming, Oxford, MS (US); Myungjin Lee, Bellevue, WA (US); Gaowen Liu, Naperville, IL (US); Ramana Rao V.R. Kompella, Foster City, CA (US)

(73) Assignee: Cisco Technology, Inc., San Jose, CA (US)

(21) Appl. No.: 19/053,005

(22) Filed: Feb. 13, 2025

(51) Int. Cl. G06N 3/082; G06N 3/0475

(52) U.S. Cl. CPC G06N 3/082; G06N 3/0475

(57) ABSTRACT

In one implementation, a device inputs a plurality of prompts to an artificial intelligence model. The device performs tracking of which parameters of the artificial intelligence model were used by the artificial intelligence model to process the plurality of prompts. The device identifies, based on the tracking, a particular parameter of the artificial intelligence model as being below a threshold amount of usage. The device adjusts the artificial intelligence model with respect to the particular parameter.

### TECHNICAL FIELD

The present disclosure relates generally to artificial intelligence and, more particularly, to inference-driven model pruning.

### BACKGROUND

Foundational models, such as large language models (LLMs), have proven capable of answer a wide range of questions and performing many different types of tasks, thanks to their very diverse training datasets. However, this versatility also comes at the price of requiring a large amount of compute resources to execute the foundation model. For instance, a modern LLM may be able to answer questions relating to topics ranging from cars, to animals, to computer networks, among others.

The versatility of foundation models is largely unneeded for many use cases, though. Indeed, end users in a given organization may only use a foundation model for a small subset of the tasks that the model is capable of performing. For instance, in the case of a company in the computer networking space, its end users are unlikely to need information from the model regarding cats, dogs, or other household animals. In such a case, the additional capabilities of the foundation model effectively represent wasted compute resources.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example of tracking parameter usage during inference by an AI model;

FIG. 6 illustrates an example of pruning a parameter from the AI model of FIG. 5; and

FIG. 7 illustrates an example simplified procedure for inference-driven model pruning, in accordance with one or more implementations described herein.

### DESCRIPTION OF EXAMPLE IMPLEMENTATIONS

### Overview

According to one or more implementations of the disclosure, a device inputs a plurality of prompts to an artificial intelligence model. The device performs tracking of which parameters of the artificial intelligence model were used by the artificial intelligence model to process the plurality of prompts. The device identifies, based on the tracking, a particular parameter of the artificial intelligence model as being below a threshold amount of usage. The device adjusts the artificial intelligence model with respect to the particular parameter

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

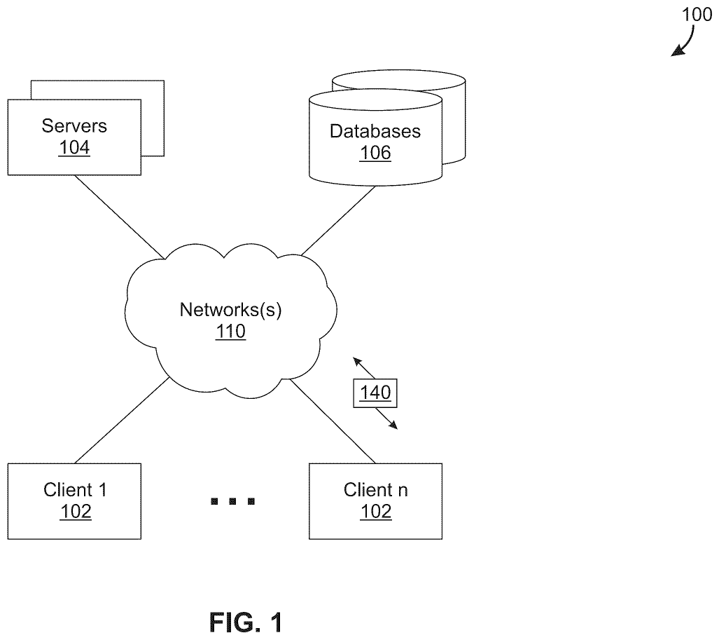

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

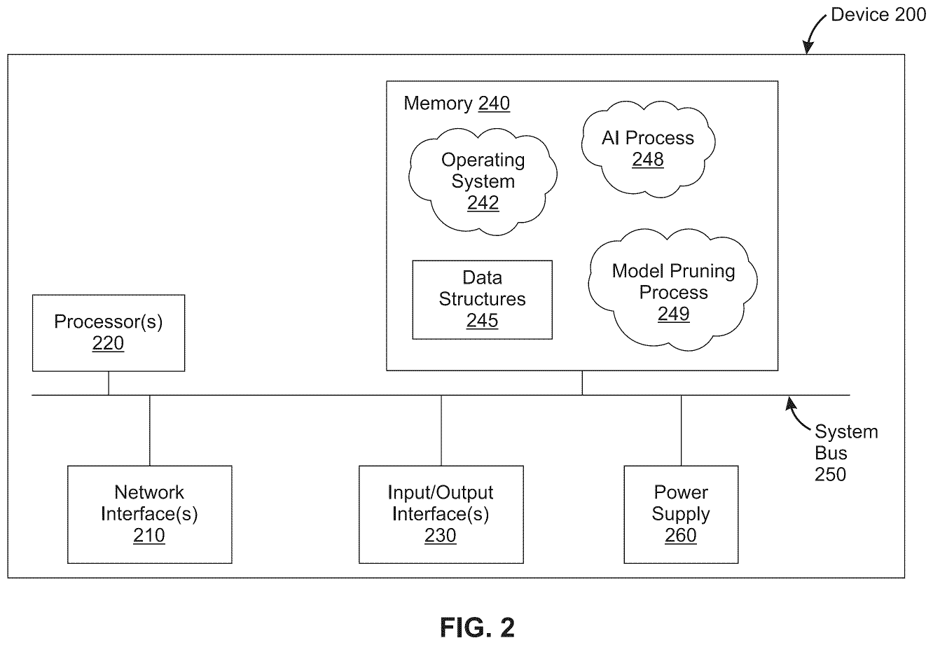

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248 and/or model pruning process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 and/or model pruning process 249 may include computer executable instructions that, when executed by processor 220, cause device 200 to perform the techniques described herein. To do so, in some implementations, AI process 248 and/or model pruning process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 and/or model pruning process 249 may employ one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI techniques that the AI process 248 and/or model pruning process 249 can leverage may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 and/or model pruning process 249 may also leverage one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 and/or model pruning process 249 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

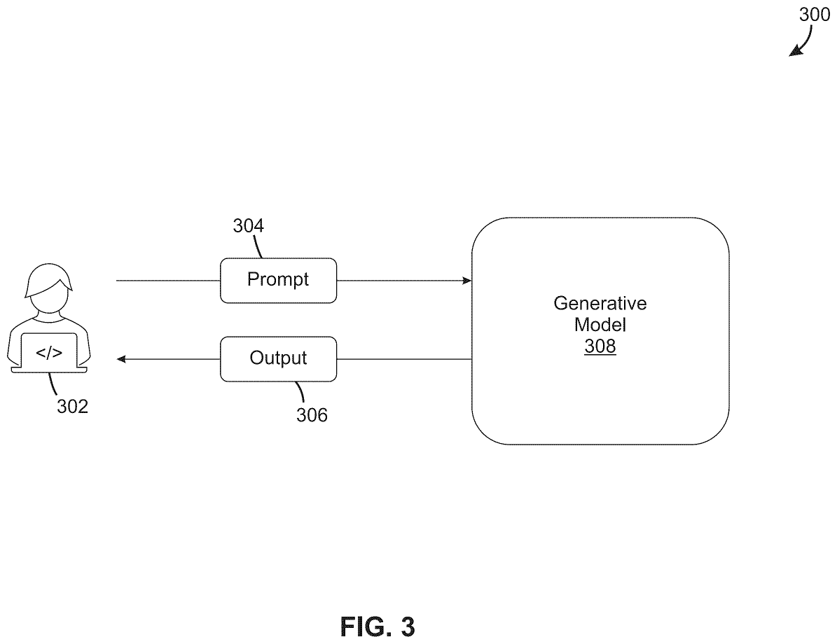

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

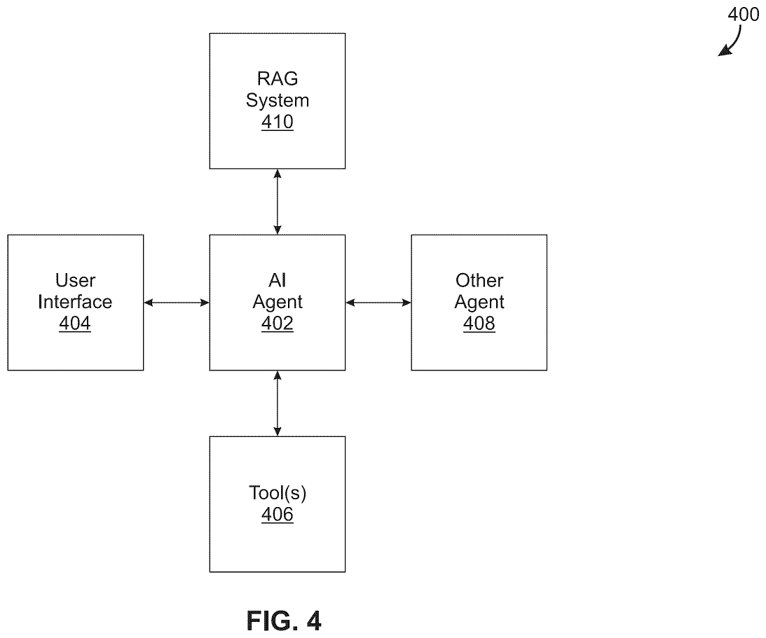

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, foundational models, such as generative model 308, those accessed by AI agent, etc., have proven capable of answer a wide range of questions and performing many different types of tasks, thanks to their very diverse training datasets. However, this versatility also comes at the price of requiring a large amount of compute resources to execute the foundation model. For instance, a modern LLM may be able to answer questions relating to topics ranging from cars, to animals, to computer networks, among others.

The versatility of foundation models is largely unneeded for many use cases, though. Indeed, end users in a given organization may only use a foundation model for a small subset of the tasks that the model is capable of performing. For instance, in the case of a company in the computer networking space, its end users are unlikely to need information from the model regarding cats, dogs, or other household animals. In such a case, the additional capabilities of the foundation model effectively represent wasted compute resources.

### Inference-Driven Model Pruning

The techniques herein introduce an inference-driven mechanism for pruning an AI model. In general, model pruning generally entails removing capabilities or knowledge from a trained model. For instance, in the case of a generative AI model, pruning the concept of ‘cat’ from the model may result in the model being unable to answer questions regarding cats or generate content (e.g., images) associated with cats. While the pruned model is less capable than its prior version, it will also typically exhibit reduced resource consumptions, as the pruned model will be smaller and more lightweight. In addition, the pruned model is also likely to exhibit improved inference times and other performance metrics with respect to the type(s) of information or capabilities that the pruned model still has.

Illustratively, the techniques described herein may be performed by hardware, software, and/or firmware, such as in accordance with AI process 248 and/or model pruning process 249, which may include computer executable instructions executed by the processor 220 (or independent processor of interfaces 210) to perform functions relating to the techniques described herein.

Specifically, according to various implementations, a device inputs a plurality of prompts to an artificial intelligence model. The device performs tracking of which parameters of the artificial intelligence model were used by the artificial intelligence model to process the plurality of prompts. The device identifies, based on the tracking, a particular parameter of the artificial intelligence model as being below a threshold amount of usage. The device adjusts the artificial intelligence model with respect to the particular parameter.

Operationally, the techniques herein introduce an approach for inference-driven pruning and unlearning for a foundation model. In general, a goal of this approach is to use the model in a production environment and to track which parameters are “active” in daily use, and which are rarely used. For instance, in the case of a large language model (LLM), this may entail tracking the queries/inference tasks asked by users in that environment and the corresponding parameters of the model that are used to generate answers.

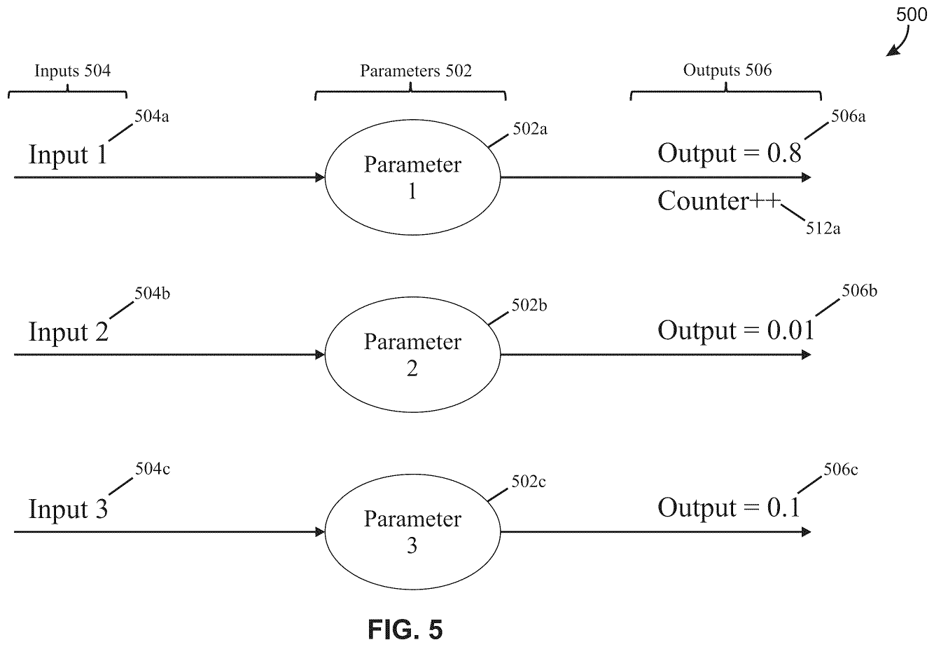

FIG. 5 illustrates an example 500 of tracking parameter usage during inference by an AI model, in various implementations. As shown, assume that the model has a plurality of parameters, parameters 502, such as a first parameter, parameter 502a, a second parameter, parameter 502b, a third parameter, parameter 502c, etc. Of course, example 500 shown is intentionally simplistic for illustrative purposes and a trained foundation model can have upwards of trillions of such parameters.

Depending on the inputs 504, the outputs 506 of parameters 502 will change. For instance, parameter 502a may produce output 506a based on input 504a, parameter 502b may produce output 506b based on input 504b, parameter 502c may produce output 506c based on input 504c., etc. For instance, say that parameter 502a is associated with the concept of ‘network routers,’ parameter 502b is associated with the concept of ‘cats,’ and parameter 502c is associated with the concept of ‘video games.’ In the case of the input prompt comprising a question about computer networks, output 506a may take on the value of ‘0.8,’ output 506b may take on the value of ‘0.01,’ and output 506c may take on the value of ‘0.1.’

In various implementations, model pruning process 249 may track the use of parameters 502 over time. As shown, for example, assume that model pruning process 249 uses a threshold of ‘0.5.’ In such a case, model pruning process 249 may then compare outputs 506 to this threshold. Based on these comparisons, model pruning process 249 may then increment a counter associated with a given parameter. For instance, since output 506a exceeds this threshold, model pruning process 249 may increment a counter 512a associated with parameter 502a. However, since neither output 506b nor output 506c exceeds this threshold, model pruning process 249 will not increment the counters for parameter 502b and parameter 502c.

In some implementations, model pruning process 249 may track each parameter for each inference by the model. In other implementations, model pruning process 249 may instead employ a sampling approach, such as by randomly assessing outputs 506 to see whether any of them exceed the threshold (e.g., for a random sampling of queries/inference tasks).

In a further implementation, model pruning process 249 may maintain the counters within GPU memory outside of the GPU executing the foundation model.

In another implementation, a given counter could even take the form of a single bit that model pruning process 249 checks or resets through sampling.

After a certain amount of time, model pruning process 249 may then use the information captured by the counters to decide which of parameters 502 to prune. For instance, model pruning process 249 may do so after observing n-number of queries/inference tasks, after a certain amount of time has elapsed, or on-demand, such as at the request of an administrator.

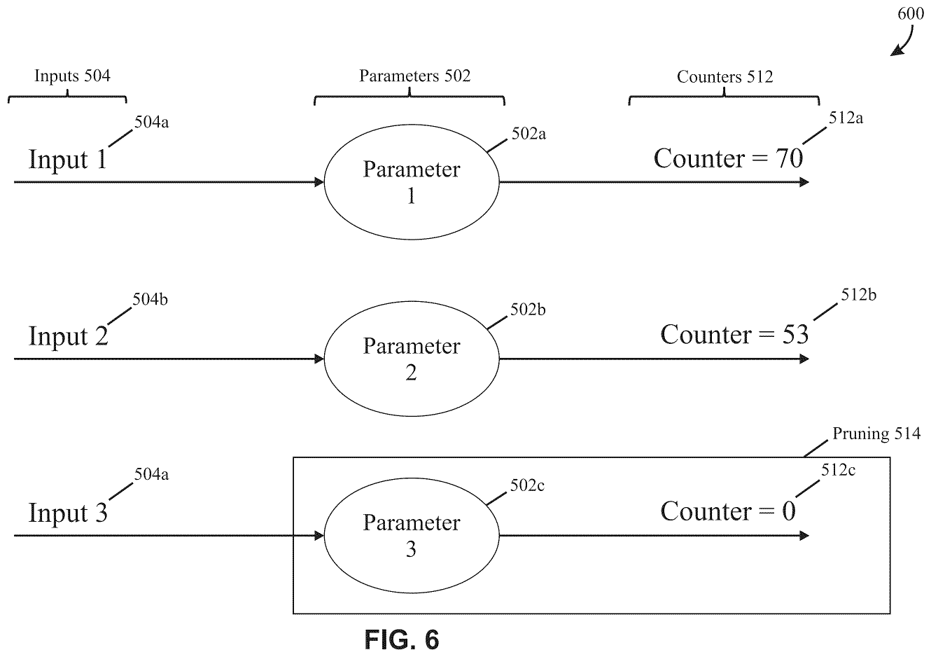

By way of example, FIG. 6 illustrates an example 600 of pruning a parameter from the AI model of FIG. 5. Continuing the previous example, assume now that model pruning process 249 has observed multiple round of inference by the model, leading to it record the following counters 512:
Counter 512a associated with parameter 502a has a count of ‘70’
Counter 512b associated with parameter 502b has a count of ‘53’
Counter 512c associated with parameter 502c has a count of ‘0’

In other words, both of parameter 502a and parameter 502b were used many times during the rounds of inference. However, parameter 502c was not. The intuition herein is that this means that the concept associated with parameter 502c is not relevant to the prompts input to the model. This presents an opportunity for model pruning process 249 to prune those unused parameters, to further optimize the model.

In some instances, model pruning process 249 may identify those of parameters 502 whose counters 512 are zero as being eligible for pruning. In other implementations, model pruning process 249 may identify the parameters eligible for pruning based on their respective whose counters 512 being below a threshold. In either case, model pruning process 249 may flag those parameters for pruning in its next phase of processing. For instance, as shown, model pruning process 249 may identify parameter 502c as being eligible for pruning 514 based on counter 512c having a count of zero.

Model pruning process 249 may conduct pruning in a variety of ways, as desired. In some instances, model pruning process 249 may simply reset the selected parameters, such as parameter 502c, to a small, potentially random value. Doing so will free up those parameters for use during retraining. In other implementations, model pruning process 249 may remove those parameters entirely from the model.

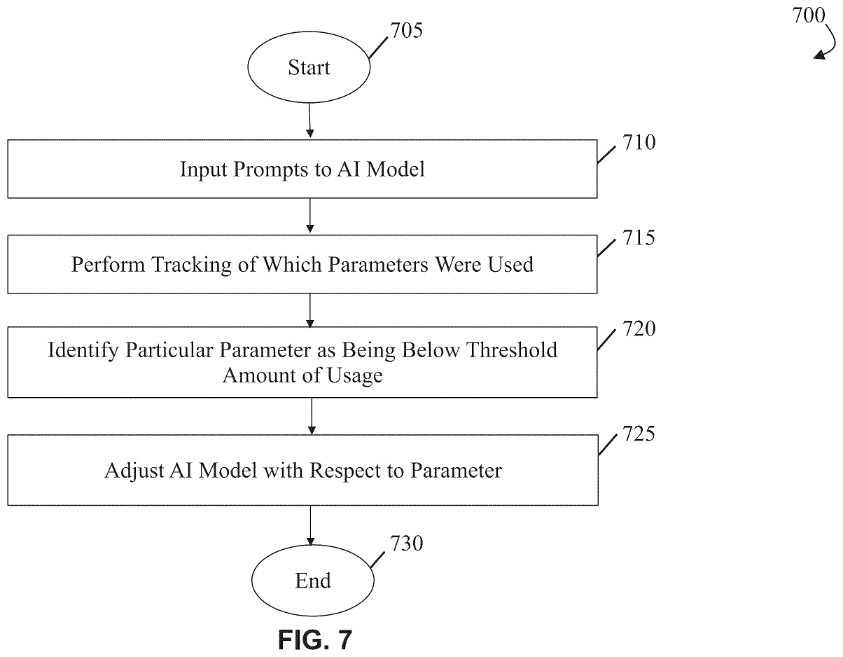

FIG. 7 illustrates an example of a simplified procedure for inference-driven model pruning, in accordance with one or more implementations described herein. For example, a non-generic, specifically configured device (e.g., device 200), may perform procedure 700 (e.g., a method) by executing stored instructions (e.g., AI process 248 and/or model pruning process 249). The procedure 700 may start at step 705, and continues to step 710, where, as described in greater detail above, the device (e.g., a controller, server, etc.) may input a plurality of prompts to an artificial intelligence model. In one implementation, the artificial intelligence model is a generative artificial intelligence model. In some cases, two or more users issue the plurality of prompts. In a further implementation, the artificial intelligence model is a large language model (LLM).

At step 715, as detailed above, the device may perform tracking of which parameters of the artificial intelligence model were used by the artificial intelligence model to process the plurality of prompts. In various implementations, the device may do so by maintaining counters associated with parameters of the artificial intelligence model and incrementing one of the counters when its associated parameter is used by the artificial intelligence model to process one of the plurality of prompts. In some implementations, the device performs the tracking for a random sampling of the plurality of prompts. In one implementation, the device performs the tracking by setting or resetting a bit associated with the particular parameter based on whether the artificial intelligence model used the particular parameter to process any of the plurality of prompts.

At step 720, the device may identify, based on the tracking, a particular parameter of the artificial intelligence model as being below a threshold amount of usage, as described in greater detail above.

At step 725, as detailed above, the device may adjust the artificial intelligence model with respect to the particular parameter. In some implementations, the device adjusts the artificial intelligence model by resetting the particular parameter to a random value prior to retraining the artificial intelligence model. In further implementations, the device adjusts the artificial intelligence model with respect to the particular parameter by performing pruning of the artificial intelligence model. In one implementation, pruning of the artificial intelligence model removes its understanding of a concept associated with the particular parameter.

Procedure 700 may then end at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for inference-driven model pruning, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
inputting, by a device, a plurality of prompts to an artificial intelligence model;
performing, by the device, tracking of which parameters of the artificial intelligence model were used by the artificial intelligence model to process the plurality of prompts;
identifying, by the device and based on the tracking, a particular parameter of the artificial intelligence model as being below a threshold amount of usage; and
adjusting, by the device, the artificial intelligence model with respect to the particular parameter.

2. The method as in claim 1, wherein the artificial intelligence model is a generative artificial intelligence model.

3. The method as in claim 1, wherein two or more users issue the plurality of prompts.

4. The method as in claim 1, wherein the device adjusts the artificial intelligence model by resetting the particular parameter to a random value prior to retraining the artificial intelligence model.

5. The method as in claim 1, wherein performing the tracking comprises:
maintaining, by the device, counters associated with parameters of the artificial intelligence model; and
incrementing, by the device, one of the counters when its associated parameter is used by the artificial intelligence model to process one of the plurality of prompts.

6. The method as in claim 1, wherein the device performs the tracking for a random sampling of the plurality of prompts.

7. The method as in claim 1, wherein the device adjusts the artificial intelligence model with respect to the particular parameter by performing pruning of the artificial intelligence model.

8. The method as in claim 7, wherein pruning of the artificial intelligence model removes its understanding of a concept associated with the particular parameter.

9. The method as in claim 1, wherein the device performs the tracking by setting or resetting a bit associated with the particular parameter based on whether the artificial intelligence model used the particular parameter to process any of the plurality of prompts.

10. The method as in claim 1, wherein the artificial intelligence model is a large language model (LLM).

11. An apparatus, comprising:
one or more network interfaces;
a processor coupled to the one or more network interfaces and configured to execute one or more processes; and
a memory configured to store a process that is executable by the processor, the process when executed configured to:
input a plurality of prompts to an artificial intelligence model;
perform tracking of which parameters of the artificial intelligence model were used by the artificial intelligence model to process the plurality of prompts;
identify, based on the tracking, a particular parameter of the artificial intelligence model as being below a threshold amount of usage; and
adjust the artificial intelligence model with respect to the particular parameter.

12. The apparatus as in claim 11, wherein the artificial intelligence model is a generative artificial intelligence model.

13. The apparatus as in claim 11, wherein two or more users issue the plurality of prompts.

14. The apparatus as in claim 11, wherein the apparatus adjusts the artificial intelligence model by resetting the particular parameter to a random value prior to retraining the artificial intelligence model.

15. The apparatus as in claim 11, wherein the apparatus performs the tracking by:
maintaining counters associated with parameters of the artificial intelligence model; and
incrementing one of the counters when its associated parameter is used by the artificial intelligence model to process one of the plurality of prompts.

16. The apparatus as in claim 11, wherein the apparatus performs the tracking for a random sampling of the plurality of prompts.

17. The apparatus as in claim 11, wherein the apparatus adjusts the artificial intelligence model with respect to the particular parameter by performing pruning of the artificial intelligence model.

18. The apparatus as in claim 17, wherein pruning of the artificial intelligence model removes its understanding of a concept associated with the particular parameter.

19. The apparatus as in claim 11, wherein the apparatus performs the tracking by setting or resetting a bit associated with the particular parameter based on whether the artificial intelligence model used the particular parameter to process any of the plurality of prompts.

20. A tangible, non-transitory, computer-readable medium storing program instructions that cause a device to execute a process comprising:
inputting, by the device, a plurality of prompts to an artificial intelligence model;
performing, by the device, tracking of which parameters of the artificial intelligence model were used by the artificial intelligence model to process the plurality of prompts;
identifying, by the device and based on the tracking, a particular parameter of the artificial intelligence model as being below a threshold amount of usage; and
adjusting, by the device, the artificial intelligence model with respect to the particular parameter.
